(19) United States
(12) Patent Application Publication
(10) Pub. No.: US 2003/0155738 A1
(43) Pub. Date: Aug. 21, 2003

(54) Bicycle folding stem with positioning structure

(75) Inventors: Robert Chen, Chang Hua Hsien (TW); Robert Hadley, Yorba Linda, CA (US); Erich A.T. Chang, Taichung (TW)

Correspondence Address: BROWDY AND NEIMARK, P.L.L.C., 624 NINTH STREET, NW, SUITE 300, WASHINGTON, DC, 20001-5303, US

(73) Assignee: RAZOR USA LLC., Cerritos, CA (US)

(21) Appl. No.: 10/187,902

(22) Filed: Jul. 3, 2002

(30) Foreign Application Priority Data
Feb. 21, 2002 (CN) 02206084.7

(51) Int. Cl. B62K 1/00

(52) U.S. Cl. 280/278

(57) ABSTRACT

A bicycle folding stem with positioning structure comprises a frame having a seat tube and a head tube. A seat post has a tube inserted into the seat tube of the frame to be lifted and lowered and to be secured at any position. A seat is mounted on an end of the seat post having a locking portion. A front fork has a tube inserted into the head tube of the frame and a fork body at the bottom end of the tube for pivoting a wheel. A stem is pivoted on the front fork at the top end thereof to be turned to the seat post for said seat post being lowered and said locking portion of said seat locked said stem.

### FIELD OF THE INVENTION

The present invention relates generally to a bicycle, and more particularly to a bicycle folding stem with positioning structure.

### BACKGROUND OF THE INVENTION

There was a conventional bicycle with a foldable stem, but there was no appropriate means being provided to secure the stem at folded position. In the prior art, there were some inventions providing securing means to lock the stem. But these securing means usually have complex structures and some securing means can not lock the stem fixedly at folded position. They increase the weight of the bicycle, and more particularly, they increase the cost to manufacture the bicycle.

### SUMMARY OF THE INVENTION

The primary objective of the invention is to provide a bicycle folding stem with positioning structure, which can lock the stem fixedly at folded position.

The second objective of the present invention is to provide a bicycle folding stem with positioning structure, which has fewer elements to lock the stem.

According to the objectives of the invention, a bicycle folding stem with positioning structure comprises a frame having a seat tube and a head tube. A seat post has a tube inserted into the seat tube of the frame to be lifted and lowered and to be secured at any position. A seat is mounted on an end of the seat post having a locking portion. A front fork has a tube inserted into the head tube of the frame and a fork body at the bottom end of the tube for pivoting a wheel. A stem is pivoted on the front fork at the top end thereof to be turned to the seat post for said seat post being lowered and said locking portion of said seat locked said stem.

### BRIEF DESCRIPTION OF THE DRAWINGS

FIG. 1 is a perspective view of a bicycle of a prefer embodiment of the present invention, showing a stem located at an unfolded position;

FIG. 2 is a perspective view of the prefer embodiment of the present invention, showing the stem being turned to a folded position;

FIG. 3 is a top view in part of the prefer embodiment of the present invention, showing the stem being turned to the folded position and being secured under a seat, and

FIG. 4 is a lateral view of FIG. 3.

### DETAIL DESCRIPTION OF THE INVENTION

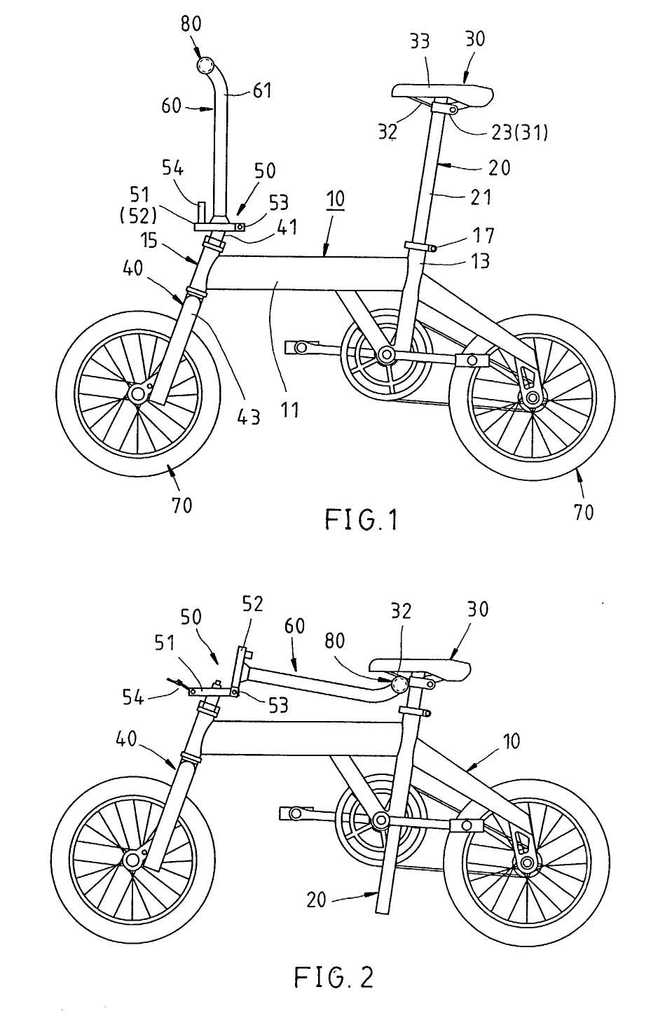

Please refer to FIGS. from FIG. 1 to FIG. 4, the prefer embodiment of the present invention provides a bicycle folding stem with positioning structure, which comprises:

A frame 10, which is to install the elements as described above and the FIGS. show one type thereof, has a frame body 11, a seat tube 13, a head tube 15 and a fastening device 17 installed on the seat tube 13.

A seat post 20 has a tube 21 and a seat coupling portion 23 at the top end of the tube 21. The tube 21 is inserted into the seat tube 13 of the frame 10 to be lifted and lowered. The fastening device 17 is to lock the tube 21 at any position.

A seat 30 is mounted on the top end of the tube 21 of the seat post 20. The seat 30 has a frame 31, two frame strips 32 which construct the locking portion as described above, and a pad member 33 mounted on the frame 31.

A front fork 40 has a tube 41 to be pivoted to the head tube 15 of the frame 10 and a fork body 43 at the bottom end of the tube 41 to pivot a wheel 70.

A folding device 50 has a first coupling seat 51 disposed at the top end of the tube 41 of the front fork 40, a second coupling seat 52 pivoted on an end of the first coupling seat 51 by means of a pin 53 and a locking device 54 to secure the first coupling seat 51 with the second coupling seat 52.

A stem 60 has a tube 61 with the bottom end thereof coupled to the second coupling seat 52 of the folding device 50 and a locking portion 63 at top end of the tube 61. A handlebar 80, which has a handle tube 81, is mounted on the locking portion 63 of the stem 60.

In operating, referring FIG. 1, the stem 60 locates at an unfolded position and the locking device 54 of the folding device 50 secures the first and the second coupling seats 51 and 52 together to make the stem 60 being fixed at the unfolded position. The seat post 20 is lifted to a predetermined to make rider having a comfortable riding posture.

To fold the stem 60, referring FIG. 2, the locking device 54 of the folding device 50 is unlocked first to make the second coupling seat 52 releasing from the first coupling seat 51. Then, the stem 60 is turned to a folded position, where the stem 60 is turned downwardly to the seat post 20.

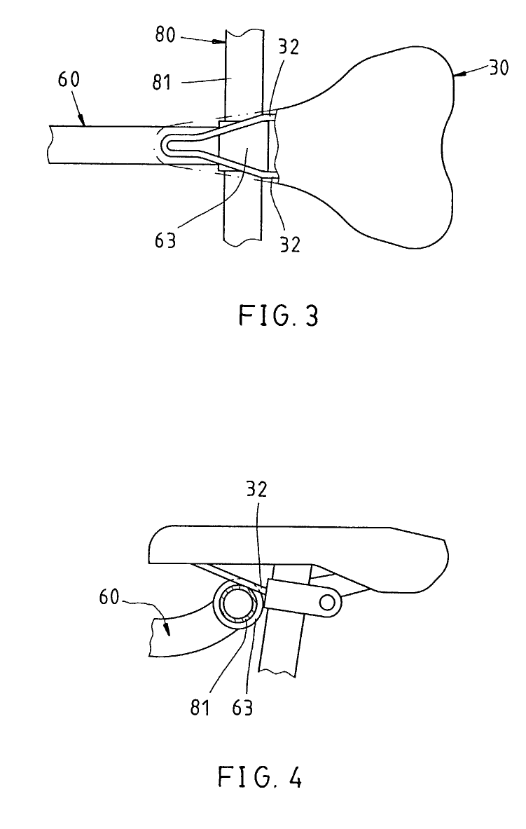

Next, referring to FIG. 3 and FIG. 4, the fastening device 17 is released to lower the seat post 20 for the frame strips 32 under the seat 30 locking the handle tube 81 of the handlebar 80 and the locking portion 63 of the stem 60. After then, the fastening device 17 is fastened again to secure the stem 60 at the folded position.

In addition, the stem can be made from a retractable tube set, which can adjust the length thereof to meet the rider's need and to make the stem being secured under the seat.

The advantages of the present invention are:

1. The locking elements are the seat post and the seat, which are original elements of the bicycle, to lock the stem at the folded position. It has an easier way to fold the stem and the stem is fixedly secured at the folded position.

2. There is no extra element provided to the bicycle of the present invention to lock the stem at the folded position. So, it will not increase the weight and the cost of the bicycle.

What is claimed is:

1. A bicycle folding stem with positioning structure, comprising:
a frame having a seat tube and a head tube;
a seat post having a tube inserted into said seat tube of said frame to be lifted and lowered and to be secured at a predetermined position;
a seat mounted on an end of said seat post having a locking portion;
a front fork having a tube inserted into said head tube of said frame and a fork body at the bottom end of said tube for pivoting a wheel;
a folding device connected on an end of said front fork, and a stem having a tube connected on said folding device and having a locking portion at top end of said tube, said stem is to be turned to the direction of said seat post while said folding device being unlocked, for said seat post being lowered and said locking portion of said seat locked said locking portion of said stem.

2. The bicycle folding stem with positioning structure as defined in claim 1, wherein comprises a fastening device disposed on said seat tube of said frame to secure said seat post.

3. The bicycle folding stem with positioning structure as defined in claim 1, wherein said locking portion of said seat is two frame strips disposed at the bottom side of said seat.

4. The bicycle folding stem with positioning structure as defined in claim 1, wherein said stem is a retractable tube set.

5. The bicycle folding stem with positioning structure as defined in claim 1, wherein said folding device comprises a first coupling seat disposed at an end of said front fork, a second coupling seat disposed at an end of said stem and a pin inserted into said first and said second coupling seats at ends thereof to pivot said second coupling seat on said first coupling seat.
